(19) United States
(12) Patent Application Publication
(10) Pub. No.: US 2009/0001226 A1
(43) Pub. Date: Jan. 1, 2009

(54) Acoustic monitoring of railcar running gear and railcars

(75) Inventor: Hal B. Haygood, Richmond, TX (US)

Correspondence Address: Houston IP Department;JACKSON WALKER L.L.P., 1401 McKinney St., Suite 1900, Houston, TX, 77010, US

(73) Assignee: RFTRAX, INC.

(21) Appl. No.: 12/215,551

(22) Filed: Jun. 27, 2008

Related U.S. Application Data
(60) Provisional application No. 60/946,643, filed on Jun. 27, 2007.

(51) Int. Cl. B61K 13/00; G06F 19/00

(52) U.S. Cl. 246/169 S; 701/19

(57) ABSTRACT

Methods and devices are provided for monitoring the condition of the running gear of a railcar utilizing acoustic/motion/vibration sensors mounted on the railcar while the railcar is underway. For some embodiments, utilizing this sensor data, defects in the running gear may be detected, and this information may be used to alert an operator to the defective condition. Operated in conjunction with a GPS or similar location detection device, a plurality of sensors mounted on a plurality of railcars may also be used to identify damaged or worn sections of track.

### CROSS-REFERENCE TO RELATED APPLICATION

This nonprovisional patent application claims priority to and the benefit of U.S. provisional patent application Ser. No. 60/946,643, filed on Jun. 27, 2007, which is hereby incorporated by reference.

### BACKGROUND

Embodiments of the present invention generally relate to detecting railcar running gear defects and, more particularly, to acoustic or vibration monitoring of railcar running gear with sensors mounted in or on the associated moving railcar.

One of the biggest challenges in maintaining and operating safe and properly maintained railroad cars, or railcars, is the ability to detect and repair worn or failing running gear on a railcar. These failures include worn or flat spots on wheels or brakes that are not releasing completely or are locked up. These worn or failing parts typically have distinctive sounds associated with them as the railcar moves down the railroad track.

To detect these events, the railroads have deployed listening devices along the tracks to listen for these failures so that the problems can be found and corrected. For example, U.S. Pat. No. 4,843,885 entitled “Acoustic Detection of Bearing Defects” teaches placing microphones beside railroad tracks to monitor the sounds emanating from the wheels and bearings of a passing railroad train in an effort to detect defective bearings. Such microphones may be placed on both sides of the track to monitor the bearings of wheels traversing both rails.

These devices, however, are limited in that they cannot monitor a railcar at every position, or even the majority of positions, along the track; it would be impractical and costly to locate these listening devices with minimal spacing to be able to monitor a railcar everywhere along miles and miles of railroad track. Because of the spacing between conventional listening devices located along the tracks, a railcar may travel several miles with a worn or failed component before being sensed by one of the listening devices, thereby potentially leading to an unsafe operating condition and unnecessary wear or damage to the particular component and surrounding parts. Another shortcoming of such listening devices is that they cannot identify the individual railcar having the worn or failing running gear with certainty. Thus, a mechanic or repair technician may need to examine the running gear of several railcars before finding the particular one with the components requiring repair or replacement.

Accordingly, there is a need for improved techniques and apparatus for acoustically monitoring and detecting defects in the running gear of railcars.

### SUMMARY

Embodiments of the present invention generally relate to detecting railcar running gear defects and, more particularly, to acoustic or vibration monitoring of railcar running gear with sensors mounted in or on the associated moving railcar.

Embodiments of the present invention provide methods and apparatus for acoustic or vibration monitoring of and detecting defects in the running gear of railcars.

One embodiment of the present invention provides a device located in or on a railcar having running gear and configured to acoustically monitor the running gear while the railcar is in motion.

Another embodiment of the present invention provides a device located in or on a railcar having running gear and configured to monitor vibration of the running gear while the railcar is in motion.

Another embodiment of the present invention is a method for determining defects in railcar running gear utilizing the acoustic signature of the running gear. The method generally includes collecting acoustic data from the running gear with a device located in or on a railcar associated with the running gear, converting the acoustic data to an acoustic signature, and comparing the acoustic signature against a plurality of known defective acoustic signatures.

Another embodiment of the present invention is a method for determining defects in railcar running gear utilizing the motion or vibration of the running gear. The method generally includes collecting accelerometer data from the running gear with a device located in or on a railcar associated with the running gear, and comparing the frequency of the accelerometer data with known frequencies for non-defective running gear. Accelerometer data frequencies falling outside the window of frequencies associated with normal operation can be used to identify worn or defective running gear or equipment.

Yet another embodiment of the present invention is a system for acoustic monitoring of railcar running gear. The system generally includes at least one railcar, a monitoring device located in or on the at least one railcar, and a broadcast means coupled to the monitoring device.

Another embodiment of the invention provides a method and system for monitoring track conditions. The system includes a plurality of railcars each having a monitoring device and a global positioning device mounted thereon. By monitoring sensor data from a plurality of railcars passing over any given location along a track, the condition of the track can be assessed.

Other features and advantages of the present invention will be apparent to those skilled in the art. While numerous changes may be made by those skilled in the art, such changes are within the spirit of the invention.

### BRIEF DESCRIPTION OF THE DRAWINGS

A more complete understanding of the present disclosure and advantages thereof may be acquired by referring to the following description taken in conjunction with the accompanying figures, wherein:

FIG. 1 is a block diagram of a device for acoustic monitoring of a railcar's running gear in accordance with an embodiment of the invention.

FIG. 2 illustrates a schematic diagram of a network of acoustic monitoring devices installed on a plurality of railcars.

While the present invention is susceptible to various modifications and alternative forms, specific exemplary embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DESCRIPTION OF PREFERRED EMBODIMENTS

Embodiments of the present invention generally relate to detecting railcar running gear defects and, more particularly, to acoustic or vibration monitoring of railcar running gear with sensors mounted in or on the associated moving railcar.

Embodiments of the present invention provide methods and apparatus for acoustically monitoring the condition of the running gear of a railcar while underway from inside or on the moving railcar. For some embodiments, the defects in the running gear may be detected, and this information may be used to alert an operator to the defective condition.

Worn or failing wheels or tapered roller bearings, such as those used in railcar running gear, produce relatively loud and distinctive sounds during operation at characteristic frequencies. These frequencies may depend on the location or type of defect (e.g., at the bearing cup, cone, or roller), the combination of the size of the wheel and the bearing capacity (e.g., a 33 inch wheel with a 70 ton capacity bearing or a 36 inch wheel with a 100 ton capacity bearing), and the speed of the train (proportional to the rotational frequency of the wheel for a given wheel diameter). Additionally, irregularities in the wheel circumference, known as “flats,” produce a characteristic frequency dependent upon the rotational frequency of the wheel. These characteristic frequencies constitute acoustic signatures that may be used to detect defects in the running gear of a corresponding railcar. In other words, because the sounds are distinctive with different characteristic frequencies, a given sound may be associated with the individual cause of the sound.

To facilitate a better understanding of the present invention, the following examples of certain embodiments are given. In no way should the following examples be read to limit, or define, the scope of the invention.

A device for monitoring the condition of the running gear (e.g., the wheels, bearings, or brakes) may be located inside or on an associated railcar having the running gear. This device may acoustically monitor the running gear using one or more suitable listening devices, such as a microphone or acoustic transducer, capable of being mounted or otherwise located in or on the railcar. The term, “microphone,” as used herein, refers to any device suitable for converting sound waves into electrical energy, including but not limited to any acoustic-to-electric transducer (e.g. an acoustic sensor). Examples of suitable microphones include microphones capable of sensing audio frequencies from about 1 kHz to about 20 kHz and may further include microphones capable of sensing ultrasonic audio frequencies of up to about 50 kHz. Other suitable ranges include, but are not limited to low audio frequencies (e.g. about 3 to about 7 kHz), medium audio frequencies (e.g. about 7 to about 14 kHz), and high audio frequencies (e.g. about 14 kHz to about 22 kHz), and ultrasonic audio frequencies (e.g. about 20-22 kHz to about 50 kHz).

For some embodiments, the acoustic monitoring device(s) may be mounted on the underside of the railcar near the wheels or anywhere in the acoustic environment of or in proximity to the railcar running gear. Such a suitable listening device may most likely possess a bandwidth encompassing the frequency range of interest. For sounds corresponding to worn or failing components, a typical audio bandwidth of approximately 5 to 20 kHz may be acceptable.

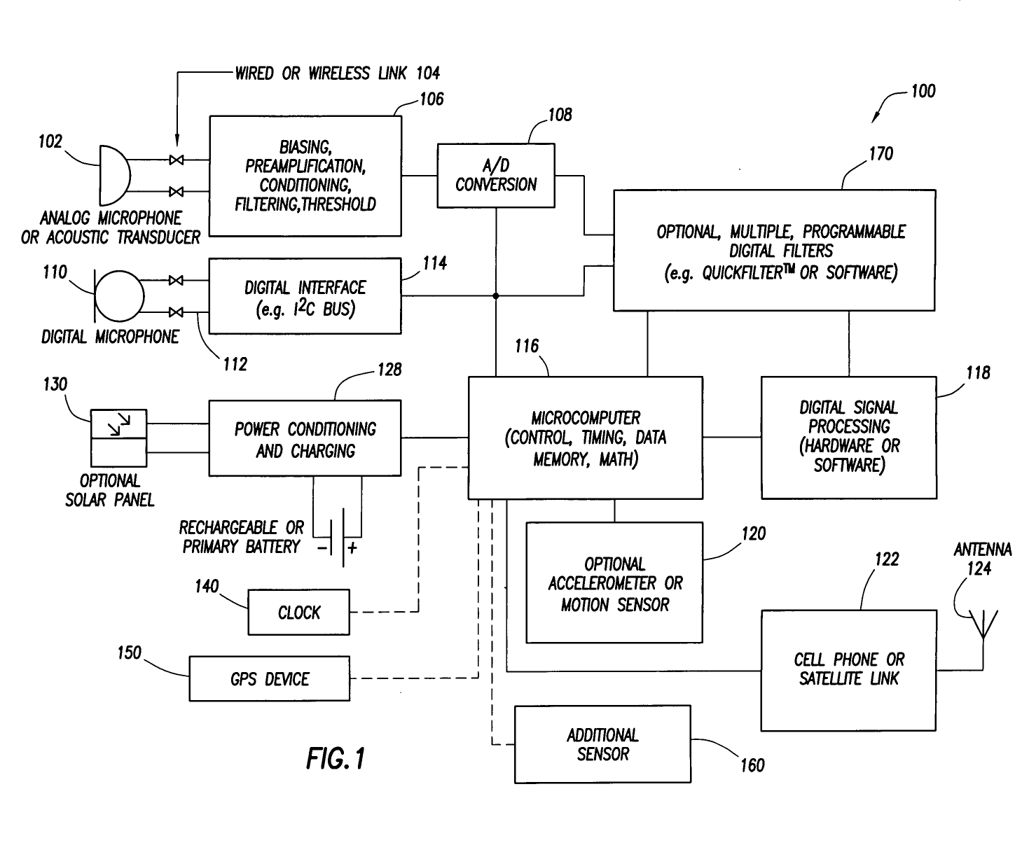

Referring now to the block diagram of FIG. 1, the device 100 may include an analog microphone 102 or acoustic transducer as the aforementioned listening device to receive sound waves from the running gear and convert the sound waves to analog electrical signals. The microphone 102 may be coupled via a wired or wireless link 104 to front-end circuitry 106, which may include protection, biasing, preamplification, filtering, or other desired signal conditioning circuitry. The conditioned electrical signals may be digitized by an analog-to-digital converter (ADC) 108 for subsequent digital signal processing and storage.

For some embodiments, a digital microphone 110 may be used in place of, or in addition to, an analog microphone to receive the sound waves from the railcar running gear and convert the sound waves to digital signals directly. The digital microphone 110 may be coupled via a wired or wireless link 112 to a digital interface 114 (e.g., I²C, SPI, USB, etc.). The digital interface 114 may be serial or parallel.

An additional benefit of a microphone sensor as described herein is that the microphone can be selectively activated by remote signal to turn the microphone on for purposes of monitoring the railcar and the environment of the railcar. For example, acoustic monitoring can be activated in cases of theft or if a railcar has been in a wreck or is burning, or has unauthorized individuals aboard the railcar.

The ADC 108 (or the digital interface 114 for some embodiments) may be coupled to a microcomputer 116, which may contain a microprocessor for control, timing, and processing functions and memory for data storage. The memory may serve as a recorder for storing the acoustic signatures or recorded sounds. This memory or a separate memory may also contain a library of exemplary defective acoustic signatures for comparison with the currently sampled acoustic signature from the running gear during operation of the railcar. In certain embodiments, the memory may be memory suitable for storing transient or nontransient data. Examples of suitable types of memory include, but are not limited to nonvolatile memory including flash memory.

For some embodiments, the microcomputer 116 may perform any desired digital signal processing on data received directly from the ADC 108 or the digital interface 114 (e.g. comparing signals to stored signatures to determine whether to generate or transmit an alert). For other embodiments, the ADC 108 (or the digital interface 114) may be coupled to digital signal processing hardware 118, such as a digital signal processor (DSP). Optional software or hardware 170, such as Quickfilter™, containing multiple programmable digital filters may be executed on the microcomputer 116 or the DSP 118 for some embodiments.

For some embodiments, a motion/vibration sensor 120, such as for example, an accelerometer, eddy current probe or similar motion/vibration sensor, may be coupled to the ADC 118, to the front-end conditioning circuitry 106, or directly to the microcomputer 116 in an effort to measure the g forces experienced by the railcar. For purposes of this description, sensor 120 will be referred to as an accelerometer. The accelerometer 120 may be capable of measuring movement, i.e., acceleration, in one or more axes, and data processed from the accelerometer 120 may be stored in memory. In one preferred embodiment, accelerometer 120 is a three-axis accelerometer. The accelerometer 120 may be situated in various positions in or on the railcar. For some embodiments, the accelerometer 120 may be placed within a housing (not shown) for the device 100, the housing being located within the railcar. For other embodiments, the accelerometer 102 may be mounted on the underside of the railcar near the wheels or mounted near the top of the railcar for increased signal-to-noise ratio (SNR), at least from side-to-side motion of the railcar.

The accelerometer 120 may be used in addition to or in place of the above described microphone sensors. Rather than detecting sound waves and converting the sound waves to digital signals that can be compared to know sound wave digital signals of running gear operating under normal conditions, the accelerometer 120 can monitor movement/vibration frequencies of the railcar and its running gear. For example, knowing the vibration frequencies of running gear operating under normal conditions, i.e., no damage and within a normal window of wear, the vibrations frequencies can be monitored for frequencies falling outside those known frequencies. In one embodiment of the invention, unit 100 can be programmed to generate an alert signal when the system detects frequencies falling outside the acceptable window of operation. Likewise, the accelerometer can be used to detect track defects, such as bumps in a track, side-to-side motion of a railcar (which may be indicative of problems with the railcar itself or the load carried by the railcar), and even predict whether the railcar is full or empty (based on movement/vibration frequencies arising from movement of the railcar).

One advantage of an accelerometer, or any other sensor 120 described herein, is that the data can be generated and transmitted in real time, so as to immediately signal a condition of interest.

If motion/vibration sensor 120 is an eddy current probe, the probe can be positioned adjacent a target surface to measure vibration of the target surface. For example, the target surface may be a rotating wheel shaft, rotating wheel, or any other reciprocating or rotating component. Again, such equipment can be characterized as having a window of vibration signatures under normal operating conditions. When monitored vibrations fall outside the known window, the vibrations may be indicative of unacceptable wear or damage with respect to the target surface. An alert signal can be generated and the monitored equipment can be checked.

The microcomputer 116 may be coupled to a broadcast interface 122, such as a cellular phone or satellite transceiver. The broadcast interface 122 may be coupled to an antenna 124 for transmitting desired data collected by the device 100 to a remote computer (not shown) for additional processing, storage, and interpretation by an operator. The antenna 124 may be located near the top of and on an external surface of the railcar.

Power to operate the device 100 may be delivered by a battery 126 coupled to power conditioning circuitry 128. For some embodiments, an optional solar panel 130 may be coupled to the power conditioning circuitry 128, which may also contain charging circuitry for recharging the battery 126. In such cases, the battery 126 should be a rechargeable battery. The solar panel 130 may be located on top of the railcar (e.g., mounted to the roofs external surface) in an effort to capture and convert the sun's energy to electrical energy. For some embodiments, the solar panel 130 may be movable; for example, the solar panel 130 may be tilted to face the sun.

The device 100 may continuously monitor the acoustic and/or motion/vibration signature of the running gear. However, such continuous monitoring may generate extraneous data, utilizing limited memory and power. Thus, for some embodiments, the device 100 may be programmed to “wake up” periodically to measure the monitored signature and then revert back to a sleep mode. For other embodiments, the device 100 may be programmed to turn on based on a triggering event or condition, such as when the railcar reaches a certain speed. Triggering events may include, but are not limited to, speed thresholds, vibration thresholds, location points, or any other threshold based upon a sensor or other input to processor 116. From this point, the device 100 may continuously or periodically monitor the acoustic/motion/vibration signature of the running gear until the condition is no longer met or after a timeout has occurred, for example.

The device 100 may electronically look for the distinctive signature sound/motion/vibration associated with each individual event, so as to identify distinctive events when they occur. This information may then be recorded as an alarm in the memory of the microcomputer 116 for some embodiments. For other embodiments, the device may record the sound for playback rather than or in addition to the electrical signal associated with the sound. The acoustic/motion/vibration signature, the alarm, or the sound recording may be broadcast via cellular technology or a satellite link to the owner(s) of the railcar or an operator monitoring the railcars, for example. The broadcast may also include, among other things, an individual railcar identification (ID) tag, a time stamp of when the event occurred, g forces measured by an accelerometer, a speed measurement measured by a speedometer, and/or a global position system (GPS) fix to know where the event occurred (e.g. via position data determined from GPS device 150).

Along similar lines, the device may be used to collect evidence of damage occurring when two railcars are coupled together. Collecting the monitored signature, the alarm, and/or the distinctive loud sound along with the GPS fix, the g forces, the time stamp, and the ID tag during a forceful railcar coupling may allow the operator to know when and where damage to a particular railcar occurred.

In certain embodiments, time stamps are generated from a time signal of clock 140 whereas in other embodiments, GPS device 150 generates the time signal.

Certain embodiments may include optional additional sensor 160. Sensor 160 may be any sensor suitable for measuring a condition of a railcar running gear including, but not limited to, an additional microphone, a nondestructive evaluation sensor, or any combination thereof. Suitable nondestructive evaluation sensors include, but are not limited to, electromagnetic acoustic transducers (EMAT) (e.g. non-contact), radiographic sensors, ultrasonic sensors, eddy current sensors, or any combination thereof. To the extent these sensors can measure dynamic conditions of the running gear, such as the eddy current probe, then such sensors can be utilized in the manner described above with respect to motion/vibration sensor 120.

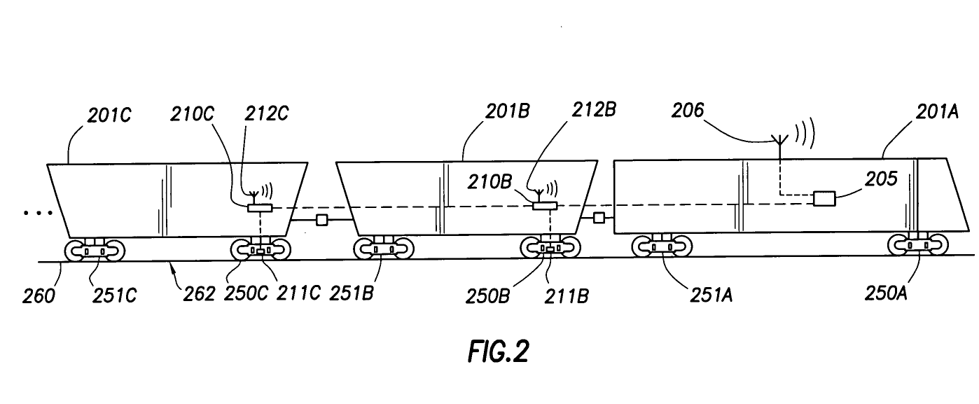

FIG. 2 illustrates a schematic diagram of a network of acoustic/motion/vibration monitoring devices installed on a plurality of railcars.

A plurality of railcars 201A-C is shown disposed on track 260, each railcar with running gear 250A, 250B, 250C, 251A, 251B, and 251C. Selected railcars 201B and 201C are shown, each with one railcar monitoring device 210B and 210C respectively. Each monitoring device 210B and 210C has an associated acoustic/motion/vibration sensor 211B and 211C mounted in proximity to railcar running gear 250B and 250C respectively. Each monitoring device 210B and 210C transmits data corresponding to the acoustic/vibration/motion signals via antennas 212B and 212C. Monitoring devices of the present invention may use any suitable communication protocol for communicating signals from monitoring devices 210B and 210C including, but not limited to, WAP, CDMA, TDMA, GSM, SMS, MMS, or any combination thereof.

Wireless receiver system 205 receives data transmitted from monitoring devices 210B and 210C and may either store the data or a portion thereof in wireless receiver system 205, generate alerts via an audible and/or visual alarms or alerts based on the data received, and/or transmit the data or a portion thereof to a remote server (not shown) via a cellular or satellite transmission via antenna 206. In certain embodiments, each monitoring device deployed to form a network may each be associated with a unique identification tag or code so as to allow identification and/or segregation of data received from each device. Additionally, a unique ID code allows alerts to be traced to specific railcars, saving time and effort.

In another embodiment of the invention, the plurality of railcars 201A-C can be used to monitor the condition of track 260. As described above, each of the running gear 250A, 250B, 250C, 251A, 251B, and 251C will have a characteristic acoustic/vibration/motion signature associated with its operation under normal conditions. However, as the running gear 250 passes over damaged portions of track 260, such as for example, at 262, the normal operating signatures of the running rear 250 will be interrupted. Rather, the operating signature of each running gear 250 passing over point 262, will fall outside the normal range at that point, such as for example, causing a spike or similar aberration in the normal data. The spike data, along with the GPS coordinates of the railcar 201 location at the time the spike is detected and recorded, is transmitted back to a central monitoring location. Spike data received from a plurality of otherwise normally operating railcars 201 for a given GPS-identified location can be used to identify damaged or worn track.

As used herein, the terms, “adapted to” and “configured to” refer to mechanical or structural connections between elements to allow the elements to cooperate to provide the described effect; these terms also refer to operational capabilities of electrical elements such as analog or digital computers or application specific devices (such as an application specific integrated circuits (ASIC)) that are programmed to perform a sequel to provide an output in response to given input signals. Furthermore, it is explicitly recognized that any of the features and elements of any of the embodiments herein may be combined with and used in conjunction with any of the features and elements of any of the other embodiments disclosed herein.

While the foregoing is directed to embodiments of the present invention, other and further embodiments of the invention may be devised without departing from the basic scope thereof, and the scope thereof is determined by the claims that follow.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Also, the terms in the claims have their plain, ordinary meaning unless otherwise explicitly and clearly defined by the patentee.

What is claimed is:

1. A method for monitoring railcars comprising:
providing a plurality of railcar acoustic monitoring devices wherein each railcar acoustic monitoring device comprises: a microphone wherein the microphone is configured to generate an acoustic signal based upon the acoustic environment thereof, a processor communicatively coupled to the microphone and configured to receive the acoustic signal, a power source electrically coupled to the processor, and a wireless transmitter communicatively coupled to the processor wherein the wireless transmitter is configured to transmit a portion of the acoustic signal;
mounting each railcar acoustic monitoring device in proximity to a railcar running gear;
transmitting data from each acoustic monitoring device corresponding to the acoustic signal via the wireless transmitter; and
receiving the data with a wireless receiver system.

2. The method of claim 1 wherein the data is an alert signal corresponding to an acoustic signature associated with a running gear defect.

3. A railcar acoustic monitoring system comprising:
railcar running gear;
a microphone disposed in proximity to the railcar running gear, the microphone configured to generate an acoustic signal associated with the running gear;
a processor communicatively coupled to the microphone and configured to receive the acoustic signal wherein the processor is communicatively coupled to a memory, the memory configured to store at least a portion of the acoustic signal therein;
a power source electrically coupled to the processor; and
a wireless transmitter communicatively coupled to the processor, the wireless transmitter configured to transmit the portion of the acoustic signal.

4. A railcar acoustic monitoring system for monitoring the railcar while it is in motion, said system comprising:
railcar running gear;
a microphone disposed in proximity to the railcar running gear, the microphone configured to generate an acoustic signal based upon the motion of the running gear;
a processor communicatively coupled to the microphone and configured to receive the acoustic signal;
memory communicatively coupled to the processor, wherein the memory is configured to store one or more acoustic signatures associated with running gear defects in the memory;
a power source electrically coupled to the processor;
wherein the processor is configured to determine whether a defect condition exists based on a comparison of the acoustic signal to the one or more acoustic signatures; and
a transmitter communicatively coupled to the processor, the transmitter configured to transmit a defect alert signal based on the defect condition being detected.

5. The railcar acoustic monitoring system of claim 4 further comprising an additional sensor wherein the additional sensor is an accelerometer communicatively coupled to the processor wherein the accelerometer is configured to send an accelerometer measurement signal to the processor.

6. The railcar acoustic monitoring system of claim 4 further comprising an additional sensor wherein the additional sensor is a speed sensor wherein the speed sensor is positioned adjacent to a rotating component of the running gear and wherein the speed sensor is communicatively coupled to the processor wherein the accelerometer is configured to send an speed measurement signal to the processor.

7. The railcar acoustic monitoring system of claim 5 wherein the processor is configured to send an impact alert signal to the transmitter upon receiving an accelerometer measurement signal that exceeds a predetermined maximum limit.

8. The railcar acoustic monitoring system of claim 6 wherein the processor is configured to send an impact alert signal to the transmitter upon receiving an accelerometer measurement signal that exceeds a predetermined maximum limit, wherein the predetermined maximum limit varies with the speed measurement signal.

9. The railcar acoustic monitoring system of claim 4 further comprising a clock communicatively coupled to the processor wherein the clock is configured to generate a time signal and wherein the processor is configured to store a sample of the acoustic signal and an associated time stamp in the memory.

10. The railcar acoustic monitoring system of claim 4 further comprising a global positioning system configured to communicate position data to the processor.

11. The railcar acoustic monitoring system of claim 10 wherein the global positioning system is configured to send a time signal to the processor and wherein the processor is configured to store a sample of the acoustic signal and an associated time stamp in the memory.

12. The railcar acoustic monitoring system of claim 11 further comprising an antenna, wherein the transmitter is a wireless transmitter and operably connected to the antenna and wherein the wireless transmitter is configured to transmit the sample and the associated time stamp.

13. The railcar acoustic monitoring system of claim 11 wherein the processor is configured to store the position data in memory and wherein the transmitter is configured to transmit the position data.

14. The railcar acoustic monitoring system of claim 4 wherein the transmitter is configured to transmit a unique identification code with any transmitted data, wherein the unique identification code is associated with the railcar acoustic monitoring device.

15. The railcar acoustic monitoring system of claim 11 further comprising an accelerometer communicatively coupled to the processor, wherein the accelerometer is configured to send an accelerometer measurement signal to the processor and wherein the transmitter is a wireless transmitter.

16. The railcar acoustic monitoring system of claim 11, wherein the processor is configured to store speed data determined from the position data in the memory and wherein the memory is nonvolatile memory.

17. The railcar acoustic monitoring system of claim 5 wherein the microphone is a digital microphone communicatively coupled to a digital interface that is communicatively coupled to the processor.

18. The railcar acoustic monitoring system of claim 17 wherein the processor comprises a microprocessor and a digital signal processor for analyzing the acoustic signal and comparing the acoustic signal to the one or more of the acoustic signatures.

19. The railcar acoustic monitoring system of claim 5 wherein the microphone is an analog microphone communicatively coupled to an adjustment circuit, wherein the adjustment circuit is configured to bias, preamplify, condition, filter, amplitude truncation, frequency truncation, or apply a threshold function to the acoustic signal and wherein the adjustment circuit is communicatively coupled to an analog to digital converter that is further communicatively coupled to the processor.

20. The railcar acoustic monitoring system of claim 5 wherein the microphone is an analog microphone communicatively coupled to an adjustment circuit, wherein the adjustment circuit is configured to bias, preamplify, condition, filter, truncate, or apply a threshold function to the acoustic signal and wherein the adjustment circuit is communicatively coupled to an analog to digital converter that is further communicatively coupled to a programmable digital filter that is further communicatively coupled to the processor.

21. The railcar acoustic monitoring system of claim 15 wherein the wireless transmitter utilizes a communications protocol, wherein the communications protocol is WAP, CDMA, TDMA, GSM, SMS, MMS, or any combination thereof.

22. The railcar acoustic monitoring system of claim 9 wherein the processor is configured to broadcast the acoustic signal via the wireless transmitter upon an occurrence of a triggering event.

23. The railcar acoustic monitoring system of claim 4 wherein the power source is a battery, a rechargeable battery, a solar panel, an electrical generator coupled to a rotating component of the railcar running gear, or any combination thereof and wherein the processor is configured to conserve power by entering a sleep mode and actuate upon receiving a wake control signal.

24. A network of acoustic monitoring devices for acoustic monitoring of railcars comprising:
a plurality of railcars, each railcar having at least one running gear;
a plurality of acoustic monitoring devices, each acoustic monitoring device disposed in proximity to the at least one running gear of each railcar, wherein each acoustic monitoring device comprises:
a microphone configured to generate an acoustic signal operation of the running gear;
a processor communicatively coupled to the microphone and configured to receive the acoustic signal;
a power source electrically coupled to the processor; and
a wireless transmitter communicatively coupled to the processor, the wireless transmitter configured to transmit a portion of the acoustic signal.

25. The network of acoustic monitoring devices of claim 24 further comprising a wireless receiver system onboard one of the railcars for receiving the portion of the acoustic signal from the wireless transmitter of each acoustic monitoring device.

26. The network of acoustic monitoring devices of claim 25 wherein the wireless receiver system further comprises a memory and wherein the wireless receiver system is further configured to store data in the memory wherein the data comprises the portion of the acoustic signal from the wireless transmitter of each acoustic monitoring device.

27. The network of acoustic monitoring devices of claim 25 wherein the wireless receiver system is further configured to transmit data wherein the data comprises the portion of the acoustic signal from the wireless transmitter of each acoustic monitoring device.

28. The network of acoustic monitoring devices of claim 25 wherein the wireless receiver system is further configured to generate an alert upon receiving an acoustic signal that is representative of a running gear defect.

29. The network of acoustic monitoring devices of claim 25 wherein the wireless receiver system is further configured to generate an alert upon receiving an acoustic signal that is outside a window of operation known to correspond to normal operating conditions.

30. A railcar monitoring system comprising:
a railcar having two sets of railcar running gear;
an motion disposed in proximity to the railcar running gear, the accelerometer configured to generate a signal based upon the movement of the railcar;
a processor communicatively coupled to the motion sensor and configured to receive signals from the motion sensor, wherein the processor is communicatively coupled to a memory, the memory configured to store at least a portion of the signals therein;
a power source electrically coupled to the processor; and
a wireless transmitter communicatively coupled to the processor, the wireless transmitter configured to transmit at least a portion of the motion sensor signals.

31. The system of claim 30, wherein said motion sensor is an accelerometer.

32. The system of claim 30, wherein said motion sensor is an eddy current probe.

33. The system of claim 30, further comprising an electronic identification associated with the motion sensor.

34. A railcar monitoring system configured to monitor the railcar while it is in motion, said system comprising:
a railcar having two sets of railcar running gear;
an accelerometer disposed in proximity to the railcar running gear, the accelerometer configured to generate a signal based upon the movement of the railcar;
a processor communicatively coupled to the accelerometer and configured to receive the signal therefrom;
memory communicatively coupled to the processor, wherein the processor is configured to store one or more predetermined signatures associated with operation of the running gear in the memory;
a power source electrically coupled to the processor;
wherein the processor is configured to determine the condition of the running gear based on comparison of the signal from the accelerometer and the one or more signatures stored in memory; and
a transmitter communicatively coupled to the processor, the transmitter configured to transmit a signal based on the determined condition of the running gear.

35. The system of claim 34, wherein the predetermined signature is that associated with defective operation of the running gear.

36. The system of claim 34, wherein the predetermined signature is that associated with normal operation of the running gear.

37. A system for monitoring the condition of railroad track, said system comprising:
a central monitoring station;
a plurality of railcars disposed on said track, wherein each railcar comprises at least one set of running gear;
an accelerometer capable of generating acceleration data signals;
a processor communicatively coupled to the accelerometer and configured to receive the signal therefrom;
a global positioning satellite device;
memory communicatively coupled to the processor, said memory having an acceleration signal range programmed thereon, which range is commiserate with normal operation of said running gear;
a power source electrically coupled to the processor;
wherein the processor is configured to determine whether the acceleration data signals from the accelerometer fall within the normal range stored in said memory; and
a transmitter communicatively coupled to the processor, the transmitter configured to transmit a track defect alert to the central monitoring station when the acceleration data signals fall outside the normal range.

38. A method for monitoring a railcar, said method comprising:
providing a railcar with a monitoring devices, wherein said monitoring device comprises: a sensor configured to generate a signal based upon movement of the railcar, a processor communicatively coupled to the sensor and configured to receive the signal, a power source electrically coupled to the processor, and a wireless transmitter communicatively coupled to the processor, wherein the wireless transmitter is configured to transmit a monitoring signal based upon the sensor signal;
mounting said monitoring device in proximity to a railcar running gear;
transmitting the monitoring signal via the wireless transmitter; and
receiving the data with a wireless receiver system.

39. The method of claim 38, wherein said transmitted monitoring signal includes an alert generated based on operation of the running gear.

40. The method of claim 38, wherein said transmitted monitoring signal includes data from said sensor.

41. The method of claim 38, wherein said sensor is an accelerometer.

42. The method of claim 38, further comprising the steps of storing one or more predetermined signatures associated with operation of the running gear in the memory of the processor;
determining the condition of the running gear based on comparison of the signal from the sensor and the one or more signatures stored in memory; and
transmitting the monitoring signal based on the determined condition of the running gear.

43. The method of claim 42, wherein the one or more predetermined signatures associated with operation of the running gear is associated with defective conditions of the running gear.

44. The method of claim 42, wherein the one or more predetermined signatures associated with operation of the running gear is associated with normal operating conditions of the running gear.

45. The method of claim 43, wherein the one or more predetermined signatures is a frequency.

46. The method of claim 44, wherein the one or more predetermined signatures is a frequency range.

47. A method for monitoring the condition of railroad track, said method comprising:
providing a plurality of railcars, each railcar having a monitoring device mounted thereon, wherein said monitoring device comprises: a sensor configured to generate a signal based upon movement of the railcar, a processor communicatively coupled to the sensor and configured to receive the signal, a global positioning satellite device, a power source electrically coupled to the processor, and a wireless transmitter communicatively coupled to the processor, wherein the wireless transmitter is configured to transmit a monitoring signal based upon the sensor signal;
storing one or more predetermined signatures associated with operation of the railcar in the memory of the processor;
moving said railcars along a length of track;
comparing the signal from the sensor with the one or more signatures stored in memory to identify a spike in the sensor signal;
identifying the location of the railcar on the track at the time of the spike utilizing the global positioning device; and
transmitting a monitoring signal to a central monitoring station upon identification of a spike in the sensor signal.

48. The method of claim 47, wherein said monitoring signal includes the location of the railcar at the time of the occurrence of the spike.

49. The method of claim 47, further comprising the step of identifying track condition for a particular location on the track based on the monitoring signal.

50. The method of claim 47, wherein said sensor is an accelerometer.

51. The method of claim 47, wherein the one or more predetermined signatures associated with operation of the railcar is associated with normal operating conditions of the railcar as it is traveling over the track.

52. The method of claim 51, wherein the one or more predetermined signatures is a frequency range.
